(19) United States
(12) Patent Application Publication
(10) Pub. No.: US 2026/0272223 A1
(43) Pub. Date: Sep. 17, 2026

(54) ACCESSORY FOR BARBECUE GRILL WITH BUILT-IN GRIPPER FOR FAT CLEANING

(71) Applicant: Ram RESHEF, Tel Aviv (IL)

(72) Inventor: Ram RESHEF, Tel Aviv (IL)

(21) Appl. No.: 19/569,132

(22) Filed: Mar. 17, 2026

Related U.S. Application Data
(60) Provisional application No. 63/773,145, filed on Mar. 17, 2025.

(51) Int. Cl. A47J 37/07

(52) U.S. Cl. CPC A47J 37/0786

(57) ABSTRACT

The present invention provides an accessory for a barbecue grill, comprising:
A tray configured to collect grease and fat drippings, designed to be removably incorporated with barbecue grill, the tray defining a longitudinal axis and having at least one waste-discharge opening;
At least one movable gripper disposed within the tray, and configured to travel along the longitudinal axis of the tray;
at least handle mechanically coupled to the gripper and extending outside the tray, wherein manual actuation of the handle causes the gripper to move along the tray and urge accumulated grease toward the waste-discharge opening.

### FIELD OF THE INVENTION

The present invention relates to an accessory for barbecue grills, specifically a tray with a built-in gripper designed for cleaning fat and grease during grilling operations.

### BACKGROUND OF THE INVENTION

Maintaining a clean grilling surface of barbecue is essential for hygiene, safety, and optimal cooking performance. Excess grease dripping and accumulation may cause undesired grease fire which is exceedingly difficult to control during grilling operations. Traditional methods involve manual scraping or wiping, which can be inefficient and hazardous. GB2516920 discloses a grill cleaning system but does not provide an integrated solution for fat removal during cooking. The present invention aims to improve upon existing solutions by incorporating a sliding gripper mechanism within a tray for more efficient grease management.

### SUMMARY OF THE INVENTION

The invention provides an accessory for a barbecue grill comprising:
A tray designed to collect grease and fat;
A built-in gripper mechanism mounted on the tray;
A handle operatively connected to the gripper, allowing it to slide along the tray;
The gripper configured to grasp and remove accumulated grease efficiently.
Optionally the gripper may have a flat surface on one side to allow blocking of airflow over burning grease fire.

This configuration ensures continuous and effortless cleaning while grilling, enhancing safety and hygiene.

The present invention provides an accessory for a barbecue grill, comprising:
A tray configured to collect grease and fat drippings, designed to be removably incorporated with barbecue grill, the tray defining a longitudinal axis and having at least one waste-discharge opening;
At least one movable elastic gripper disposed within the tray, and configured to travel along the longitudinal axis of the tray;
at least handle mechanically coupled to the gripper and extending outside the tray, wherein manual actuation of the handle causes the gripper to move along the tray and urge accumulated grease toward the waste-discharge opening.

According to some embodiments of the present invention the at least one gripper is designed to travel along the tray toward a central slit, guided by at least one handle, wherein the gripper is actuated by a push-pull mechanism, where a rod of the gripper passes through a guiding hole, in the tray, ensuring smooth, controlled movement.

According to some embodiments of the present invention the at least one gripper is shaped to conform to the width of the tray, maximizing coverage and ensuring complete waste collection.

According to some embodiments of the present invention the gripper comprising a spring-assisted return mechanism incorporated into the accessory, enabling automatic retraction and prevent unintended movement and maintains the gripper's position when not in use.

According to some embodiments of the present invention the gripper further comprising a locking system incorporated into the accessory enabling automatic retraction and prevent unintended movement and maintain the gripper's position when not in use.

According to some embodiments of the present invention the at least one gripper is designed with two arm sets, each comprising two arms connected by a hinge, allowing the arms to move horizontally across the tray surface while ensuring smooth operation without interfering with grilling operations.

According to some embodiments of the present invention each set consists of two arms connected by a hinge, forming a scissor-like or parallelogram linkage.

According to some embodiments of the present invention wherein one of the arms in each set is connected to the tray via a rotating screw, which serves as a pivot point.

According to some embodiments of the present invention the actuated, the arms move in a coordinated manner, allowing the gripper to sweep or grip the contents on the tray to the slit in the middle of the tray.

According to some embodiments of the present invention the handle is mechanically coupled to the gripper.

According to some embodiments of the present invention the handle is coupled to the gripper implementing electrical mechanism.

According to some embodiments of the present invention the barbecue gripper has a curved or sloped design, with a narrow end on one side optimized for gripping and collecting debris, while the opposite flat end functions as a flame blocker.

According to some embodiments of the present invention the handle is rotated to slightly lift the gripper after cleaning, minimizing friction and facilitating reset to its original position.

According to some embodiments of the present invention the handle is rotated to place the flat side of the gripper downwards for blocking airflow in case of grease fire.

According to some embodiments of the present invention accessory further comprising an external scraper, operated via a handle enabling controlled movement of an arm across the barbecue burner covers to efficiently remove accumulated grease and debris.

The present invention discloses an accessory for a barbecue grill, comprising:
A movable tray configured to collect grease and fat drippings, designed to be incorporated with barbecue grill above the grate;
dual gripper conveyor mechanism incorporates at least one independent conveyor mechanism, each positioned on opposite sides of the tray. wherein each conveyor mechanism consists of a conveyor belt, which has at least one gripping parts
   wherein the conveyor belt rotates around a set of two supporting rods, ensuring smooth movement.

According to some embodiments of the present invention rotation is manually controlled via handles which are mechanically linked to the conveyor system, allowing the user to activate and control the movement of the belts as needed.

The present invention discloses s barbecue grill, comprising:
a grill body;
a cooking grate;
A tray configured to collect grease and fat drippings, designed to be removably incorporated above the grill body, the tray defining a longitudinal axis and having at least one waste-discharge opening;
At least one movable gripper disposed within the tray, and configured to travel along the longitudinal axis of the tray;
at least handle mechanically coupled to the gripper and extending outside the tray, wherein manual actuation of the handle causes the gripper to move along the tray and urge accumulated grease toward the waste-discharge opening.

### BRIEF DESCRIPTION OF THE SCHEMATICS

The present invention will be more readily understood from the detailed description of embodiments thereof made in conjunction with the accompanying drawings of which:

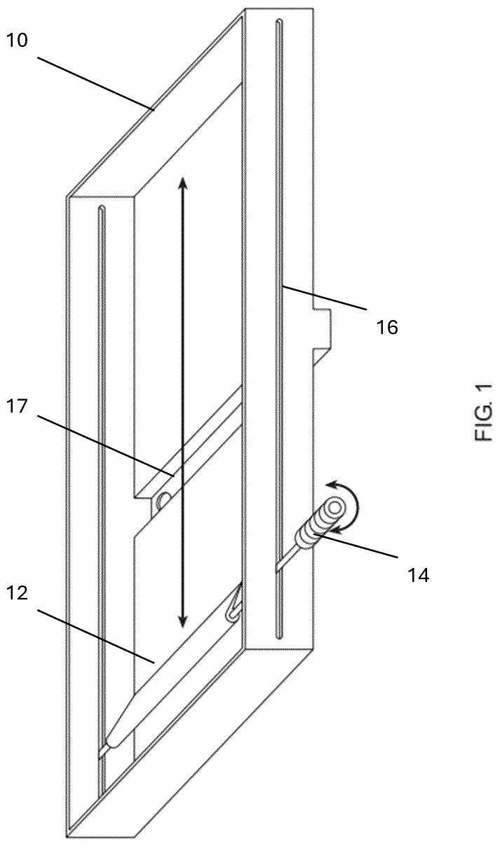

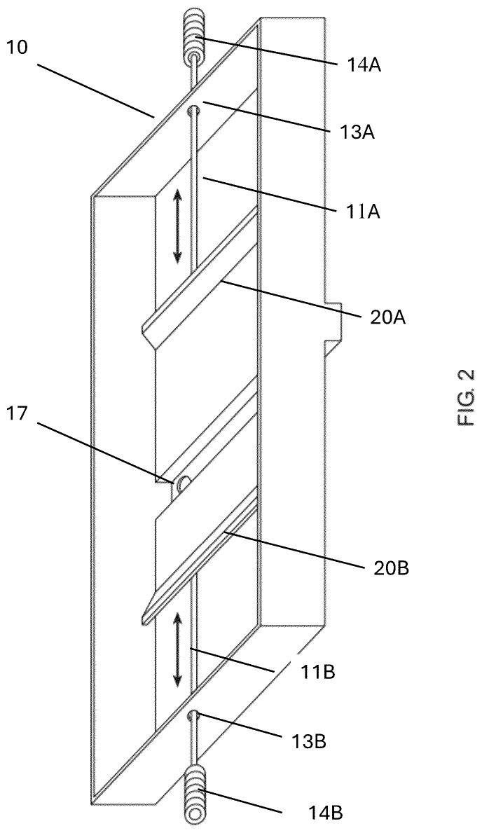

FIG. 1: Perspective view of showing the components of the tray and gripper mechanism using handle first implementation, according to some embodiments of the present invention.

FIG. 2: Perspective view of showing the components of the tray and gripper mechanism using handle second implementation, according to some embodiments of the present invention.

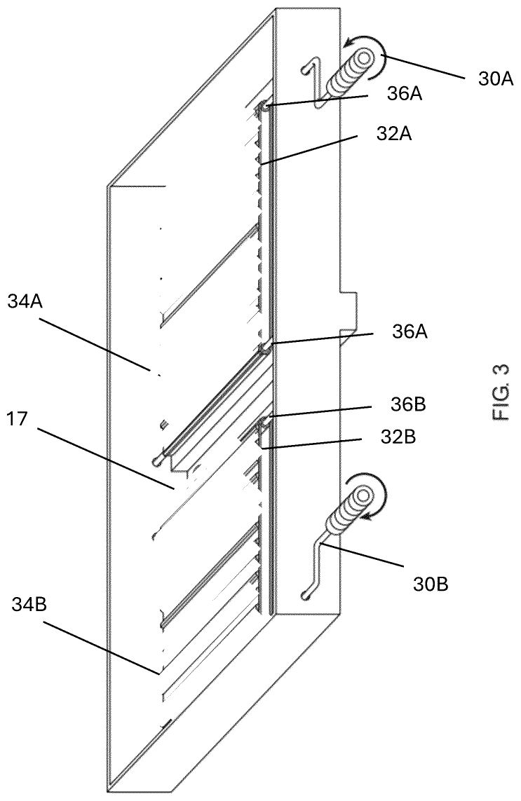

FIG. 3: Perspective view of showing the components of the tray and gripper conveyor mechanism, according to some embodiments of the present invention the tray.

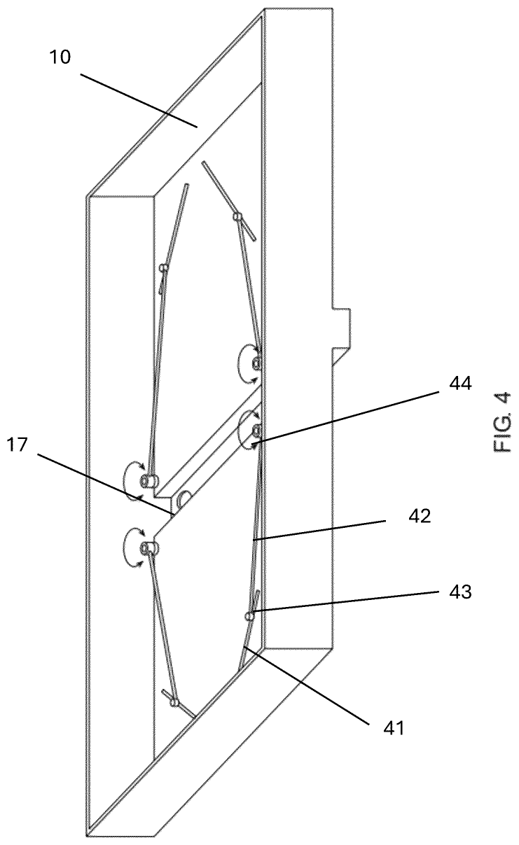

FIG. 4: Perspective view of showing the components of the tray and gripper mechanism fourth implementation, according to some embodiments of the present invention.

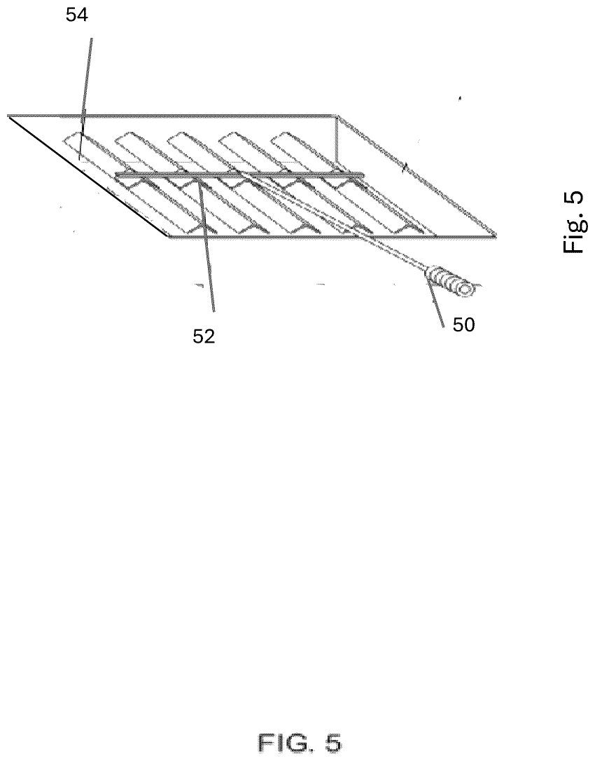

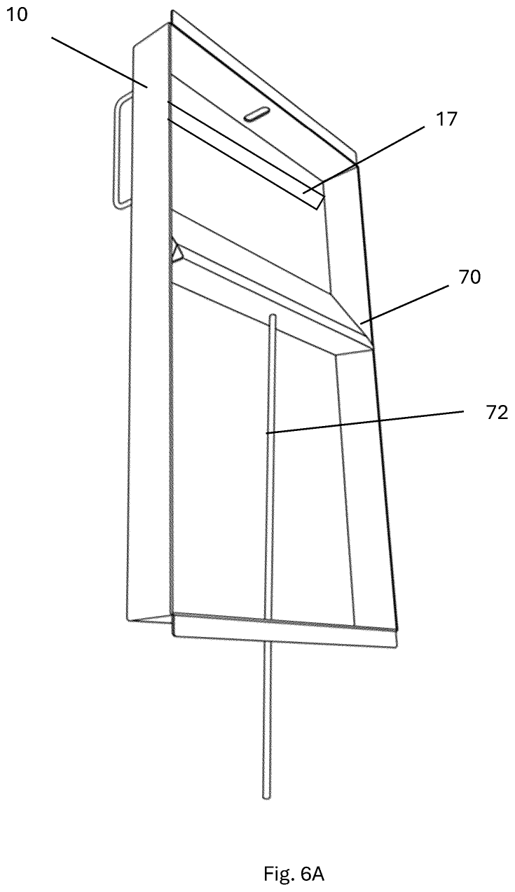

FIG. 5: Perspective view of showing the components of the burner covers and external grippers first implementation, according to some embodiments of the present invention.

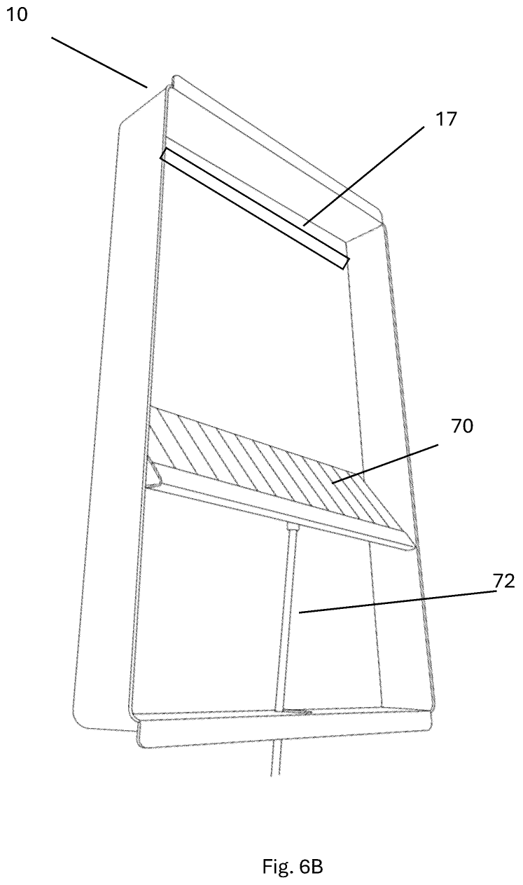

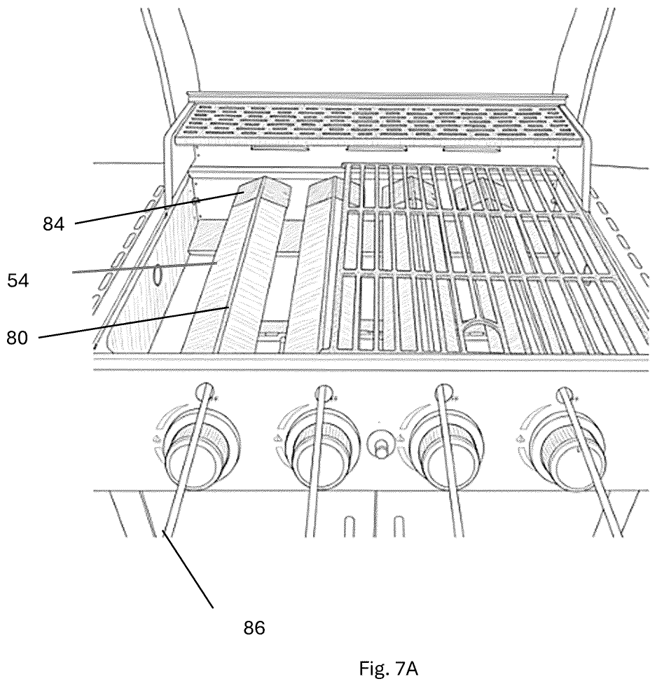

FIG. 6A: Perspective view of showing the components of the tray and gripper mechanism fifth implementation, according to some embodiments of the present invention.

FIG. 6B: Perspective enlarged view of showing the components of the tray and gripper mechanism fifth implementation, according to some embodiments of the present invention.

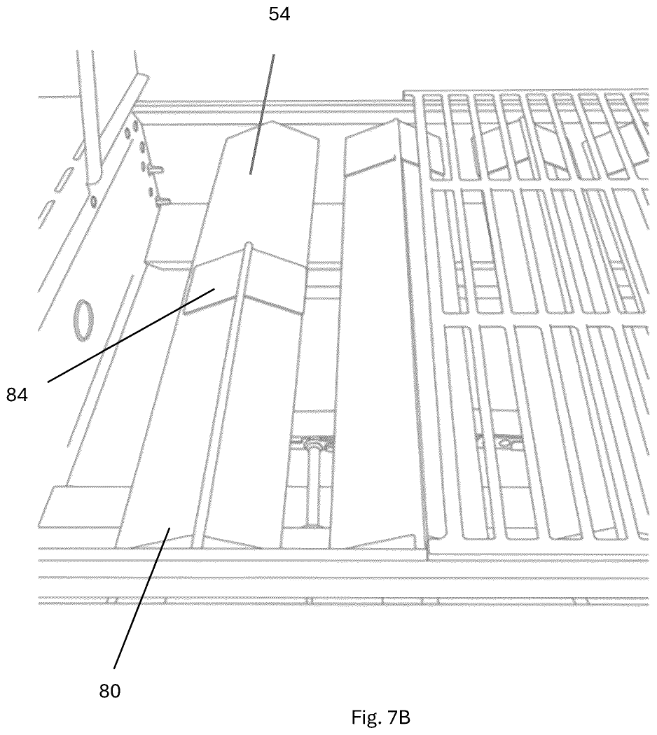

FIG. 7A: Perspective view of showing the components of the burner covers and external grippers second implementation, according to some embodiments of the present invention.

FIG. 7B: Perspective enlarged view of showing the components of the burner covers and external grippers second implementation, according to some embodiments of the present invention.

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting FIG. 1: Perspective view of showing the components of the tray and gripper mechanism using handle first implementation, according to some embodiments of the present invention. FIG. 1 illustrates the accessory mounted onto a barbecue grill, demonstrating its seamless integration with the cooking surface. The tray (10) is positioned beneath the grilling area to collect fat drippings and food debris, while the gripper mechanism (12) is aligned within the tray and designed to move sideways along a track, ensuring efficient collection and disposal of grease and debris. The movement of the gripper is manually controlled by pushing pulling, sliding, or twisting the handle (14).

In some embodiments, the barbecue gripper is elastic, enabling movements along the tray in different surface conditions. In some embodiments, the barbecue gripper features a curved or sloped design, with a narrow end on one side optimized for gripping and collecting debris, while the opposite flat end functions as a flame blocker. This dual-purpose design enhances efficiency and heat management, allowing the gripper to effectively sweep grease and residues at one state and one another state shielding specific areas of the grill from direct flames, ensuring controlled heat distribution.

The handle (14) serves a dual function:
It allows the gripper to move horizontally along the track when pushed or pulled.
It can also be rotated to slightly lift the gripper after cleaning, minimizing friction and facilitating reset to its original position.
Optionally rotating the handle to place the flat side downwards for blocking airflow in case of grease fire.

As the gripper moves, it sweeps, pushes, or guides collected fat drippings and debris toward the designated slit (17) in the center of the tray, directing waste to a drainage or collection area.

The gripper may be equipped with interchangeable or integrated cleaning elements, such as: Flexible wiper blades for efficient grease removal, Rigid scraping edges for clearing stubborn residues, Perforated filters to separate solid food debris from liquid drippings, ensuring smoother disposal.

Once the gripper reaches the opposite end of the tray, all collected waste is fully funneled out or redirected to a slit 17 in the middle of the tray.

This design ensures efficient cleaning and maintenance, preventing grease buildup while maintaining uninterrupted grilling performance.

### Alternative Gripper Mechanism Designs

a. Magnetically Guided Gripper
   The handle controls a magnet positioned outside the tray, while the gripper has a magnetic counterpart inside the tray.
   Moving the external magnet slides the internal gripper along the track.
   This design eliminates the need for exposed mechanical linkages, making it easier to clean and more resistant to grease buildup.
B. Spring-loaded Gripper With One-way Clutch
   A spring-loaded mechanism keeps the gripper under tension, allowing it to sweep automatically when triggered.
   A one-way clutch ensures movement in a single direction.
c. electrically operated gripper, using an electric actuator to control the movement/actuation of the gripper.

FIG. 2 presents a perspective view detailing the key components of the second embodiment of the gripper mechanism components, including the tray (10), two grippers (20A, 20B), and two handles (14A, 14B).

Each gripper is designed to travel along the tray toward the central slit (17), guided by the handles (14A, 14B). The grippers are actuated by a push-pull mechanism, where the rod (11A,11B) passes through a guiding hole (13A,13B), ensuring smooth, controlled movement.

Each gripper (20A, 20B) is initially positioned at opposite ends of the tray (10).

In its default state, the gripper remains stationary, allowing fat drippings and food debris to accumulate in the tray.

When the user pushes the handle (14A or 14B), the connected rod (11A, 11B) transmits force to the gripper, causing it to slide forward along the tray.

As the gripper moves, it sweeps, scrapes, or channels debris toward the central slit (17) for disposal.

The gripper is shaped to conform to the width of the tray, maximizing coverage and ensuring complete waste collection.

The surface of the gripper may feature: Rubberized edges for smooth sweeping, Serrated blades for breaking down stubborn residues, Perforations to separate solid debris from liquid grease, optimizing drainage.

The user can pull the handle in the opposite direction, returning the gripper to its starting position for continuous operation.

Optionally A spring-assisted return mechanism or a locking system may be incorporated to Reduce user effort and enable automatic retraction, prevent unintended movement, and maintain the gripper's position when not in use.

FIG. 3: Perspective view illustrating the components of the tray and the dual gripper conveyor mechanism third embodiment, according to certain embodiments of the present invention.

The system incorporates two independent conveyor mechanisms, each positioned on opposite sides of the tray. (10)

Each conveyor mechanism consists of a conveyor belt (32A/32B), which features at least one gripping part (34A/34B). This gripping element is designed to capture, transport, and direct debris, grease, or food residue toward a central slit (17) for disposal.

The conveyor belt (32A/32B) rotates around a set of two supporting rods (36A/36B), ensuring smooth movement.

The belt is shaped to conform to the width of the tray, ensuring maximum coverage and efficient collection.

The rotation is manually controlled via handles (30A/30B), which are mechanically linked to the conveyor system, allowing the user to activate and control the movement of the belts as needed.

Each conveyor mechanism extends from one end of the tray to the central slit (17), efficiently guiding debris to the collection point without (interfering with) grilling operations.

FIG. 4 provides perspective view, focusing on the gripper mechanism (41) according to the fourth embodiment. The gripper is designed with two arm sets (42), each comprising two arms connected by a hinge (43). This unique configuration allows the arms to move horizontally across the tray surface while ensuring smooth operation without interfering with grilling operations.

Each set consists of two arms connected by a hinge, forming a scissor-like or parallelogram linkage.

One of the arms in each set is connected to the tray via a rotating screw (44), which serves as a pivot point.

In the default position, the arms are either fully retracted (compact position) or partially extended, depending on the design.

When actuated, the arms move (extending or contracting) in a coordinated manner, allowing the gripper to sweep or grip the contents on the tray to the slit 17 in the middle.

The rotating screw acts as a guiding mechanism, ensuring controlled movement without deviation.

This movement can be linear (straight across the tray) or slightly arched, depending on the pivot configuration.

As the gripper moves across the tray, it sweeps grease drippings, food debris, charcoal, or any other waste residue toward the slit 17.

The gripping edges may include rubberized tips, serrated metal edges, or perforated filters to enhance efficiency.

### Optional Reset Mechanism

After completing a full movement cycle, the gripper retracts to its original position, either manually or with assistance from springs or counterweights.
The hinge system ensures that both arm sets move in synchronization, preventing jamming or misalignment.

FIG. 5: Perspective view of showing the components of the gas burner covers (54) and external scraper (52), according to some embodiments of the present invention.

FIG. 5 presents a perspective view, illustrating the interaction between the external scraper (52) and the gas burner covers (54). The scraper is operated via a handle (50), enabling controlled movement across the burner covers to efficiently remove accumulated grease and debris. As the scraper moves, it loosens and directs residues downward, allowing them to travel into the tray for easy disposal. This design ensures efficient maintenance and prolonged burner performance, reducing grease buildup and enhancing overall grilling hygiene.

FIG. 6A: Perspective view of showing the components of the tray and gripper mechanism fifth implementation, according to some embodiments of the present invention.

FIG. 6A provides perspective view, focusing on the gripper mechanism (70) according to the fourth embodiment. The gripper is designed with at least one arm (72). This unique configuration allows the arm to move horizontally across the tray surface while ensuring smooth operation without interfering with grilling operations.

In the default position, the arm is either fully retracted (compact position) or partially extended, depending on the design.

When actuated, the arm moves (extending or contracting) in a coordinated manner, allowing the gripper to sweep or grip the contents on the tray to the slit 17.

FIG. 6B: Perspective enlarged view of showing the components of the tray and gripper mechanism fifth implementation, according to some embodiments of the present invention. The gripper scraper may have flexible edge to allowing minimal gap with tray surface, in order to sweep debris more efficiently.

FIG. 7A: Perspective view of showing the components of the burner covers and external grippers second implementation, according to some embodiments of the present invention.

FIG. 7A presents a perspective view, illustrating the interaction between the external scraper (84) and the gas burner covers (54). The scraper is operated via a handle (86), enabling controlled movement of an arm 80 across the burner covers to efficiently remove accumulated grease and debris. As the scraper moves, along the burner covers ensures efficient maintenance and prolonged burner performance, reducing grease buildup and enhancing overall grilling hygiene.

FIG. 7B: Perspective enlarged view of showing the components of the burner covers and external scraper second implementation, according to some embodiments of the present invention.

The embodiments of the scraper of FIG. 5 and FIG. 7A&B, can be implemented together with the different embodiments of the gripper, providing integrated solution of keeping the grill clean at different location of the barbeque apparatus, one at burner cover and one at the tray above the grill body.

According to some embodiments of the present invention rotation is manually controlled via handles which are mechanically linked to the conveyor system, allowing the user to activate and control the movement of the belts as needed.

The present invention discloses s barbecue grill, comprising:
a grill body;
a cooking grate;
A tray configured to collect grease and fat drippings, designed to be removably incorporated above the grill body, the tray defining a longitudinal axis and having at least one waste-discharge opening;
At least one movable gripper disposed within the tray, and configured to travel along the longitudinal axis of the tray;
at least handle mechanically coupled to the gripper and extending outside the tray, wherein manual actuation of the handle causes the gripper to move along the tray and urge accumulated grease toward the waste-discharge opening.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. An accessory for a barbecue grill, comprising:
A tray configured to collect grease and fat drippings, designed to be removably incorporated with barbecue grill, positioned beneath the grilling area, the tray defining a longitudinal axis and having at least one waste-discharge opening;
At least one movable elastic gripper disposed within the tray, and configured to travel along the longitudinal axis of the tray;
at least one handle coupled to the gripper and extending outside the tray, wherein manual actuation of the handle causes the gripper to move along the tray and urge accumulated grease towards the waste-discharge opening.

2. The accessory of claim 1 wherein the at least one gripper is designed to travel along the tray towards a central slit, guided by at least one handle, wherein the gripper is actuated by a push-pull mechanism, where a rod of the gripper passes through a guiding hole, in the tray, ensuring smooth, controlled movement.

3. The accessory of claim 1 wherein the at least one gripper is shaped to conform to the width of the tray, maximizing coverage and ensuring complete waste collection.

4. The accessory of claim 1 comprising a spring-assisted return mechanism incorporated into the accessory, enabling automatic retraction and preventing unintended movement and maintains the gripper's position when not in use.

5. The accessory of claim 1 comprising a locking system incorporated into the accessory enabling automatic retraction and prevent unintended movement and maintain the gripper's position when not in use.

6. The accessory of claim 1 the at least one gripper is designed with two arm sets, each comprising two arms connected by a hinge, allows the arms to move horizontally across the tray surface while ensuring smooth operation without interfering with grilling operations.

7. The accessory of claim 6 wherein, each set consists of two arms connected by a hinge, forming a scissor-like or parallelogram linkage.

8. The accessory of claim 7 wherein one of the arms in each set is connected to the tray via a rotating screw, which serves as a pivot point.

9. The accessory of claim 7 wherein the actuated, the arms move in a coordinated manner, allowing the gripper to sweep or grip the contents on the tray to the slit in the middle of the tray.

10. The accessory of claim 1 comprising a magnetically Guided Gripper, wherein the handle controls a magnet positioned outside the tray, while the gripper has a magnetic counterpart inside the tray.

11. The accessory of claim 1 wherein the handle is mechanically coupled to the gripper.

12. The accessory of claim 1 wherein the handle is coupled to the gripper actuation implementing electrical mechanism.

13. The accessory of claim 1 wherein barbecue gripper has a curved or sloped design, with a narrow end on one side optimized for gripping and collecting debris, while the opposite flat end functions as a flame blocker.

14. The accessory of claim 1 wherein the handle is rotated to slightly lift the gripper after cleaning, minimizing friction and facilitating reset to its original position.

15. The accessory of claim 1 wherein the handle is rotated to place the flat side of the gripper downwards for blocking airflow in case of grease fire.

16. The accessory of claim 1 further comprising an external scraper, operated via a handle enabling controlled movement of an arm across the barbecue burner covers to efficiently remove accumulated grease and debris, providing integrated solution for keeping the grill clean at different location of the barbeque apparatus..

17. An accessory for a barbecue grill, comprising:
A movable tray configured to collect grease and fat drippings, designed to be incorporated with barbecue grill;
o dual gripper conveyor mechanism incorporates at least one independent conveyor mechanism, each positioned on opposite sides of the tray;
wherein each conveyor mechanism consists of a conveyor belt; having at least one protruding gripping part;
wherein the conveyor belt rotates around a set of two supporting rods, ensuring smooth movement.

18. The accessory of claim 17 wherein the rotation is manually controlled via handles which are mechanically linked to the conveyor system, allowing the user to activate and control the movement of the belts as needed.

19. A barbecue grill, comprising:
a grill body;
a cooking grate;
A tray configured to collect grease and fat drippings, designed to be removably incorporated above the grill body, the tray defining a longitudinal axis and having at least one waste-discharge opening;
At least one movable gripper disposed within the tray, and configured to travel along the longitudinal axis of the tray;
at least handle mechanically coupled to the gripper and extending outside the tray, wherein manual actuation of the handle causes the gripper to move along the tray and urge accumulated grease toward the waste-discharge opening.
